(19) United States
(12) Patent Application Publication
(10) Pub. No.: US 2025/0298868 A1
(43) Pub. Date: Sep. 25, 2025

(54) Software License Enforcement

(71) Applicant: Rakuten Symphony, Inc., Tokyo (JP)

(72) Inventors: Tushar Doshi, Santa Clara, CA (US); Lakshay Badlani, Hayward, CA (US)

(21) Appl. No.: 18/041,781

(22) PCT Filed: Dec. 15, 2022
(86) PCT No.: PCT/US2022/052994

§ 371 Date: Feb. 15, 2023

(51) Int. Cl. G06F 21/10

(52) U.S. Cl. CPC G06F 21/105

(57) ABSTRACT

A global license server transmits temporary licenses to a scheduling component for controlling access to managed software by a host such as a cluster, one or more servers, or a cloud computing platform. The scheduling component, when functioning normally, periodically transmits heartbeat messages to the global license server. If the global license server fails to receive heartbeat messages, the global license server instructs the scheduling component to expire the current temporary license for the host. The global license server may also blacklist the host such that the global license server will not transmit additional temporary licenses for the host.

### BACKGROUND

### Field of the Invention

This invention relates to software licensing enforcement.

### Background of the Invention

Many software providers use a software as a service (SaaS) model for selling software to clients. In this approach, a client does not buy a copy of an executable but rather pays a periodic, e.g., annual or monthly, fee for continued access to software. The SaaS model has the advantage of providing a continued revenue stream for the provider and ongoing support and updates for the client. The SaaS model relies on the ability of the provider to enforce licensing of executables and prevent attempts to use executables more or for longer than the client has paid for.

It would be an advancement in the art to facilitate the enforcement of licensing of software.

### SUMMARY OF THE INVENTION

An apparatus includes a computing device including one or more

processing devices and one or more memory devices operably coupled to the one or more processing devices. The one or more memory devices store executable code that, when executed by the one or more processing devices, causes the one or more processing devices to transmit a first temporary license with an expiration date to a component executing on a host. The first temporary license authorizes the component to enable execution of managed software on the host. If a predefined time elapses without receiving a heartbeat message from the component, the component is instructed to expire the first temporary license.

### BRIEF DESCRIPTION OF THE DRAWINGS

In order that the advantages of the invention will be readily understood, a more particular description of the invention briefly described above will be rendered by reference to specific embodiments illustrated in the appended drawings. Understanding that these drawings depict only typical embodiments of the invention and are not therefore to be considered limiting of its scope, the invention will be described and explained with additional specificity and detail through use of the accompanying drawings, in which:

FIG. 1 is a schematic block diagram of a network environment in which licensed software may be deployed in accordance with an embodiment;

FIG. 2 is a schematic block diagram showing components for enforcing licenses in accordance with an embodiment;

FIG. 3A is a process flow diagram of a method for providing licenses by a global license server in accordance with an embodiment;

FIG. 3B is a process flow diagram of a method for a scheduling component to coordinate with a global license server in accordance with an embodiment; and

FIG. 4 is a schematic block diagram of an example computing device suitable for implementing methods in accordance with embodiments of the invention.

### DETAILED DESCRIPTION

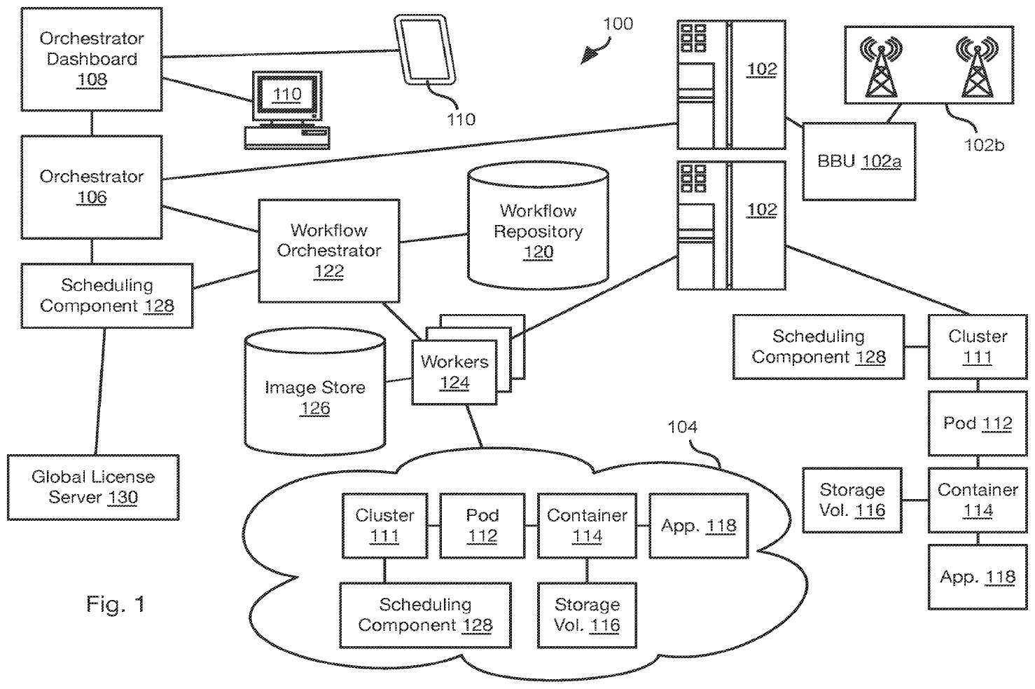

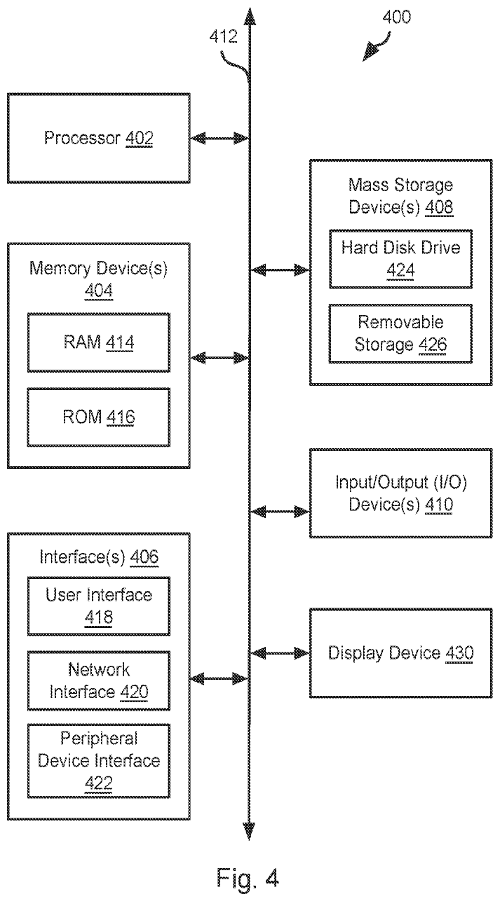

FIG. 1 illustrates an example network environment 100 in which the systems and methods disclosed herein may be used. The components of the network environment 100 may be connected to one another by a network such as a local area network (LAN), wide area network (WAN), the Internet, a backplane of a chassis, or other type of network. The components of the network environment 100 may be connected by wired or wireless network connections. The network environment 100 includes a plurality of servers 102. Each of the servers 102 may include one or more computing devices, such as a computing device having some or all of the attributes of the computing device 400 of FIG. 4.

Computing resources may also be allocated and utilized within a cloud computing platform 104, such as amazon web services (AWS), GOOGLE CLOUD, AZURE, or other cloud computing platform. Cloud computing resources may include purchased physical storage, processor time, memory, and/or networking bandwidth in units designated by the provider by the cloud computing platform.

In some embodiments, some or all of the servers 102 may function as edge servers in a telecommunication network. For example, some or all of the servers 102 may be coupled to baseband units (BBU) 102a that provide translation between radio frequency signals output and received by antennas 102b and digital data transmitted and received by the servers 102. For example, each BBU 102a may perform this translation according to a cellular wireless data protocol (e.g., 4G, 5G, etc.). Servers 102 that function as edge servers may have limited computational resources or may be heavily loaded.

An orchestrator 106 provisions computing resources to application instances 118 of one or more different application executables, such as according to a manifest that defines requirements of computing resources for each application instance. The manifest may define dynamic requirements defining the scaling up or scaling down of a number of application instances 118 and corresponding computing resources in response to usage. The orchestrator 106 may include or cooperate with a utility such as KUBERNETES to perform dynamic scaling up and scaling down the number of application instances 118.

An orchestrator 106 may execute on a computer system that is distinct from the servers 102 and is connected to the servers 102 by a network that requires the use of a destination address for communication, such as using a networking including ethernet protocol, internet protocol (IP), Fibre Channel, or other protocol, including any higher-level protocols built on the previously-mentioned protocols, such as user datagram protocol (UDP), transport control protocol (TCP), or the like.

The orchestrator 106 may cooperate with the servers 102 to initialize and configure the servers 102. For example, each server 102 may cooperate with the orchestrator 106 to obtain a gateway address to use for outbound communication and a source address assigned to the server 102 for use in inbound communication. The server 102 may cooperate with the orchestrator 106 to install an operating system on the server 102. For example, the gateway address and source address may be provided and the operating system installed using the approach described in U.S. application Ser. No. 16/903,266, filed Jun. 16, 2020 and entitled AUTOMATED INITIALIZATION OF SERVERS, which is hereby incorporated herein by reference in its entirety.

The orchestrator 106 may be accessible by way of an orchestrator dashboard 108. The orchestrator dashboard 108 may be implemented as a web server or other server-side application that is accessible by way of a browser or client application executing on a user computing device 110, such as a desktop computer, laptop computer, mobile phone, tablet computer, or other computing device.

The orchestrator 106 may cooperate with the servers 102 in order to provision computing resources of the servers 102 and instantiate components of a distributed computing system on the servers 102 and/or on the cloud computing platform 104. For example, the orchestrator 106 may ingest a manifest defining the provisioning of computing resources to, and the instantiation of, components such as a cluster 111, pod 112 (e.g., KUBERNETES pod), container 114 (e.g., DOCKER container), storage volume 116, and an application instance 118. The orchestrator may then allocate computing resources and instantiate the components according to the manifest.

The manifest may define requirements such as network latency requirements, affinity requirements (same node, same chassis, same rack, same data center, same cloud region, etc.), anti-affinity requirements (different node, different chassis, different rack, different data center, different cloud region, etc.), as well as minimum provisioning requirements (number of cores, amount of memory, etc.), performance or quality of service (QoS) requirements, or other constraints. The orchestrator 106 may therefore provision computing resources in order to satisfy or approximately satisfy the requirements of the manifest.

The instantiation of components and the management of the components may be implemented by means of workflows. A workflow is a series of tasks, executables, configuration, parameters, and other computing functions that are predefined and stored in a workflow repository 120. A workflow may be defined to instantiate each type of component (cluster 111, pod 112, container 114, storage volume 116, application instance, etc.), monitor the performance of each type of component, repair each type of component, upgrade each type of component, replace each type of component, copy (snapshot, backup, etc.) and restore from a copy each type of component, and other tasks. Some or all of the tasks performed by a workflow may be implemented using KUBERNETES or other utility for performing some or all of the tasks.

The orchestrator 106 may instruct a workflow orchestrator 122 to perform a task with respect to a component. In response, the workflow orchestrator 122 retrieves the workflow from the workflow repository 120 corresponding to the task (e.g., the type of task (instantiate, monitor, upgrade, replace, copy, restore, etc.) and the type of component. The workflow orchestrator 122 then selects a worker 124 from a worker pool and instructs the worker 124 to implement the workflow with respect to a server 102 or the cloud computing platform 104. The instruction from the orchestrator 106 may specify a particular server 102, cloud region or cloud provider, or other location for performing the workflow. The worker 124, which may be a container, then implements the functions of the workflow with respect to the location instructed by the orchestrator 106. In some implementations, the worker 124 may also perform the tasks of retrieving a workflow from the workflow repository 120 as instructed by the workflow orchestrator 122. The workflow orchestrator 122 and/or the workers 124 may retrieve executable images for instantiating components from an image store 126.

In some embodiments, a scheduling component 128 may execute in the network environment 100. The scheduling component 128 may execute on a server 102 implementing a cluster 111 (e.g., executing a KUBERNETES master for a cluster 111) or some other computing device. The scheduling component 128 may execute on a server 102 or other computing device executing the orchestrator 106, orchestrator dashboard 108, workflow orchestrator 122, and one or more of the workers 124. There may be multiple scheduling components 128 executing in some or all of the above-described locations or a single scheduling component 128.

The scheduling component 128 coordinates with a global licensing server 130. The global licensing server 130 is a computer system owned or controlled by the entity providing software such as software implementing the orchestrator 106, workflow orchestrator 122, and/or workers 124. The global license server 130 may be a computer system owned or controlled by the entity providing software implementing one or more of the cluster 111, pod 112, container 114, storage volumes 116, and application instances 118. In some implementations, each cluster 111 is implemented as a KUBERNETES master and each pod 112 is implemented using a KUBERNETES Kubelet. However, the servers 102 implementing the clusters 111 and pods 112 may execute one or more items of software that are agents of the orchestrator 106. Use of the software implementing the agents may also be managed by the global licensing server. For example, a container runtime interface (CRI) used by each pod 112 may be implemented as an agent of the orchestrator 106. The scheduling component 128 may be used to coordinate with a global licensing server 130 to enforce licensing of any software and is not limited to those components described above. In the following description, reference is made to “managed software,” which may include any of the above referenced examples or any other type of software.

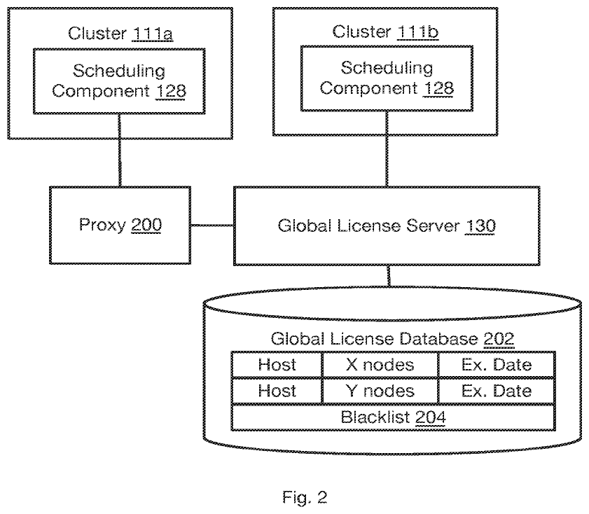

Referring to FIG. 2, a scheduling component 128 may execute in (e.g., on the same hosts) each cluster 111a, 111b. The scheduling component 128 for each cluster 111a, 111b may execute on a separate computing device from the cluster 111a, 111b controlled by the scheduling component 128 and communicate with the hosts of the cluster 111a, 111b by means of a network. The scheduling components 128 may connect to the global license server 130 directly or by way of a proxy server 200.

The global license server 130 may manage and/or access a global license database 202. For example, the global license database 202 may include entries, each including a host identifier that identifies a domain, one or more hosts, an identifier C1, C2 of a cluster 111a, 111b or some other host identifier. Each entry may further include a number of nodes (e.g., X or Y, where X and Y are integers) licensed, and an expiration date for the license of the cluster 111a, 111b. The number of nodes may refer to a number of containers 114 in a cluster 111a, 111b that may be managed by an orchestrator 106, agents of the orchestrator 106, or other component executing the managed software. The number of nodes may refer to a number of instances of the managed software that may be simultaneously executed in a cluster 111a, 111b. The number of nodes may refer to a number of computing devices, processor cores, or other units of hardware that may be in a cluster 111a, 111b executing the managed software.

The global license database 202 may store a blacklist 204. The blacklist 204 may list information for users, organizations, cluster identifiers, domains, internet protocol (IP) addresses, usernames, or other identifiers associated with attempts to use the managed software without acquiring a license authorizing that use.

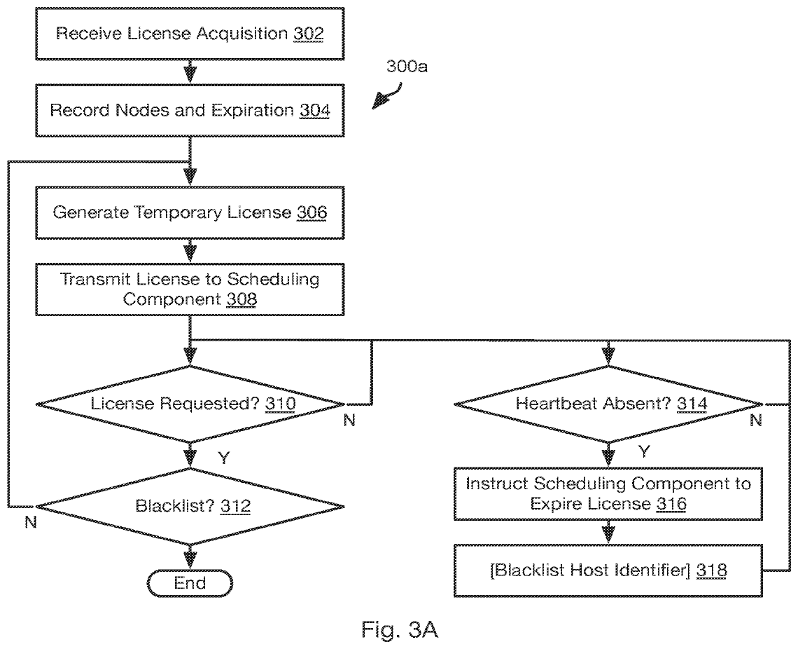

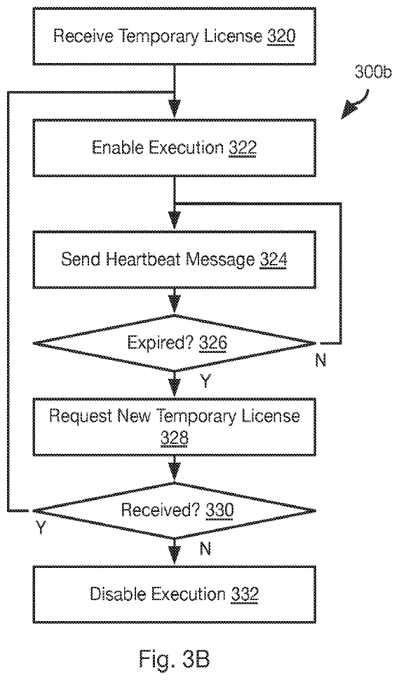

FIG. 3A illustrates a method 300a that may be executed by a global license server 130 in order to control access to the managed software by a host. The host may be a cluster, one or more servers, computing resources in a cloud computing platform 104, or some other computing device. The method 300a may include receiving 302 a license acquisition. Receiving 302 a license acquisition may include receiving a notification that a user or organization has purchased a license. The notification may include an identifier of a domain, one or more hosts, cluster identifier, or other identifier (hereinafter “host identifier”). The notification may include a number of nodes and an expiration date for the license. The notification may be received from an interface, such as a webpage, by which users may select license parameters (host identifier, number of nodes, expiration, date, etc.) and provide payment or proof of payment.

The method 300a may include recording 304 an entry in the global license database 202 that includes some or all of the host identifier, number of nodes, and the expiration date. The method 300a may further include generating 306 a temporary license. The temporary license may be a file that is encrypted, signed, or otherwise secured in order to enable verification of the accuracy of the file. The temporary license may be code that is associated with a file stored by the global license database 202 such that a presenter of the code will be granted permissions indicated in the file. The file may indicate the number of nodes, a host identifier, and a temporary expiration date. The temporary expiration date may occur much sooner than the expiration date of the license acquisition from step 302 such that multiple temporary licenses will need to be required before the expiration data is reached. For example, the expiration date may be months or years in the future whereas the temporary license expires only one or more days or weeks in the future.

The temporary license may then be transmitted to a scheduling component 128 executing on a host identified in the host identifier of the temporary license. Subsequent actions may then be performed. Since the only a temporary license was transmitted 308 (“the first temporary license”), the scheduling component 128 will request a second temporary license when the first temporary license is about to expire (e.g., within one hour, one day, or within some other time window). If a temporary license is found 310 to be requested by the scheduling component 128, the method 300a may include evaluating 312 whether the host or an entity associated with the host executing the scheduling 128, or otherwise requesting a new license by way of the scheduling component, is included in the blacklist 204. If not, processing continues at step 306 with the generation 306 of a new temporary license expiring at a point in the future equal to the expiration date of the preceding temporary license plus some duration, such as one or more days, weeks, or months.

The method 300a may further include evaluating 314 whether a heartbeat is absent from the scheduling component 128. As discussed in greater detail below, the scheduling component 128 may periodically (e.g., every hour, day, or some other interval) transmit heartbeat messages to the global license server 130. The heartbeat messages indicate that the scheduling component 128 is functioning correctly and is properly controlling usage of the managed software on one or more hosts referenced by the host identifier in the temporary license.

A user may attempt to circumvent controls of the scheduling component 128 may stopping the scheduling component 128, cutting off communication of the scheduling component 128 from a network, manipulating a clock used by the scheduling component 128 to delay expiration of the temporary license, or perform other actions in order to obtain usage of the managed software without payment. Accordingly, any of such actions would result in the scheduling component 128 ceasing to periodically transmit heartbeat messages to the global license server 130 at a predefined interval. The heartbeat may be found 314 to be absent if an above-threshold number of intervals (e.g., one, two, or more) elapse without receiving any heartbeat message.

If the heartbeat is found 314 to be absent, the global license server 130 may instruct 316 the scheduling component 128 to expire the temporary license last received by the scheduling component. Instructing 316 the scheduling component 128 to expire the temporary license may include transmitting the instruction to the host executing the scheduling component 128. If the scheduling component 128 is disabled or otherwise isolated from the global license server 130 the instruction from step 316 may not be received. Step 316 may additionally or alternatively include providing the instruction in response to the scheduling component 128 making contact with the global license server 130 at some point after the heartbeat is found 314 to be absent.

The method 300a may include adding 318 the host identifier to the blacklist 204 such that acquisition of additional temporary licenses is no longer permitted for the host identifier or an entity associated with the host identifier. Adding 318 the host identifier to the blacklist 204 may be subject to one or more criteria in addition to finding 314 the heartbeat to be absent. For example, if the heartbeat is found 314 to be absent, a strike may be recorded for the host identifier. If, a predefined number, e.g. 2, 3, 4 or some other number, of strikes are accumulated for a host identifier, then the host identifier may be added 318 to the blacklist 204.

FIG. 3B illustrates a method 300b that may be executed by the scheduling component 128 with respect to a host having a corresponding host identifier that executes the managed software. The scheduling component 128 may execute on the host or on some other computing device connected to the host by a network. The scheduling component 128 may perform the method 300b in cooperation with the global license server 130.

The scheduling component 128 receives 320 the temporary license transmitted to the scheduling component 128 by the global license server 130 at step 308 of the method 300a. In response to receiving 320 the temporary license, the scheduling component 128 enables 322 execution of the managed software on the host. Enabling 322 execution may include enabling execution of a number of instances of the managed software specified in the temporary license. Enabling 322 execution may include enabling execution the managed software to manage a number of containers, hosts, or other entities as specified in the temporary license.

Enabling and disabling execution of the managed software may be performed using any approach known in the art for enabling or disabling access to software. For example, interfaces through which commands are input may be configured to receive commands only when enabled to do so in response to instructions from the scheduling component 128. One or more components of the managed software may be configured only to function upon receiving a heartbeat or other signal from the scheduling component 128. Any approach for enabling or prohibiting function of a software component on an ongoing basis may be used.

Following step 322, the scheduling component 128 may begin sending 324 heartbeat messages with respect to the host to the global license server at an interval as described above. The scheduling component 128 may be configured to send the heartbeat messages when the scheduling component 128 is functioning after receiving the temporary license. The scheduling component 128 may be configured to suppress the heartbeat message in response to detecting actions intended to circumvent access controls of the scheduling component 128, such as manipulating a clock on one or more hosts executing the scheduling component 128 or the managed software.

Upon determining 326 that the temporary license has expired or is about to expire, e.g., is within one hour, one day, or some other time period from expiration, the scheduling component 128 requests 328 a new temporary license from the global license server 130. If the new temporary license is found 330 to have been received, then processing continues at step 322 with execution of the managed software being re-enabled or remaining enabled until the expiration of the new temporary license.

If no new temporary license is found 330 to have been received, then execution of the managed software is disabled 332. Execution of the managed software may be disabled 332 upon expiration of the temporary license either with or without some grace period beyond the time of expiration of the temporary license. Note also that the scheduling component 128 will also disable 332 execution of the managed software and expire the temporary license regardless of the expiration date of the temporary license when instructed to do so at step 316 of the method 300a.

FIG. 4 is a block diagram illustrating an example computing device 400. Computing device 400 may be used to perform various procedures, such as those discussed herein. The servers 102, orchestrator 106, workflow orchestrator 122, cloud computing platform 104, scheduling component 128, and global license server 130 may each be implemented using one or more computing devices 400. The orchestrator 106, and workflow orchestrator 122, and scheduling component 128 may be implemented on different computing devices 400 or a single computing device 400 may execute two or more of the orchestrator 106, workflow orchestrator 122, and scheduling component 128.

Computing device 400 includes one or more processor(s) 402, one or more memory device(s) 404, one or more interface(s) 406, one or more mass storage device(s) 408, one or more Input/output (I/O) device(s) 410, and a display device 430 all of which are coupled to a bus 412. Processor(s) 402 include one or more processors or controllers that execute instructions stored in memory device(s) 404 and/or mass storage device(s) 408. Processor(s) 402 may also include various types of computer-readable media, such as cache memory.

Memory device(s) 404 include various computer-readable media, such as volatile memory (e.g., random access memory (RAM) 414) and/or nonvolatile memory (e.g., read-only memory (ROM) 416). Memory device(s) 404 may also include rewritable ROM, such as Flash memory.

Mass storage device(s) 408 include various computer readable media, such as magnetic tapes, magnetic disks, optical disks, solid-state memory (e.g., Flash memory), and so forth. As shown in FIG. 4, a particular mass storage device is a hard disk drive 424. Various drives may also be included in mass storage device(s) 408 to enable reading from and/or writing to the various computer readable media. Mass storage device(s) 408 include removable media 426 and/or non-removable media.

I/O device(s) 410 include various devices that allow data and/or other information to be input to or retrieved from computing device 400. Example I/O device(s) 410 include cursor control devices, keyboards, keypads, microphones, monitors or other display devices, speakers, printers, network interface cards, modems, lenses, CCDs or other image capture devices, and the like.

Display device 430 includes any type of device capable of displaying information to one or more users of computing device 400. Examples of display device 430 include a monitor, display terminal, video projection device, and the like.

Interface(s) 406 include various interfaces that allow computing device 400 to interact with other systems, devices, or computing environments. Example interface(s) 406 include any number of different network interfaces 420, such as interfaces to local area networks (LANs), wide area networks (WANs), wireless networks, and the Internet. Other interface(s) include user interface 418 and peripheral device interface 422. The interface(s) 406 may also include one or more peripheral interfaces such as interfaces for printers, pointing devices (mice, track pad, etc.), keyboards, and the like.

Bus 412 allows processor(s) 402, memory device(s) 404, interface(s) 406, mass storage device(s) 408, I/O device(s) 410, and display device 430 to communicate with one another, as well as other devices or components coupled to bus 412. Bus 412 represents one or more of several types of bus structures, such as a system bus, PCI bus, IEEE 1394 bus, USB bus, and so forth.

For purposes of illustration, programs and other executable program components are shown herein as discrete blocks, although it is understood that such programs and components may reside at various times in different storage components of computing device 400, and are executed by processor(s) 402. Alternatively, the systems and procedures described herein can be implemented in hardware, or a combination of hardware, software, and/or firmware. For example, one or more application specific integrated circuits (ASICs) can be programmed to carry out one or more of the systems and procedures described herein.

In the above disclosure, reference has been made to the accompanying drawings, which form a part hereof, and in which is shown by way of illustration specific implementations in which the disclosure may be practiced. It is understood that other implementations may be utilized and structural changes may be made without departing from the scope of the present disclosure. References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

Implementations of the systems, devices, and methods disclosed herein may comprise or utilize a special purpose or general-purpose computer including computer hardware, such as, for example, one or more processors and system memory, as discussed herein. Implementations within the scope of the present disclosure may also include physical and other computer-readable media for carrying or storing computer-executable instructions and/or data structures. Such computer-readable media can be any available media that can be accessed by a general purpose or special purpose computer system. Computer-readable media that store computer-executable instructions are computer storage media (devices). Computer-readable media that carry computer-executable instructions are transmission media. Thus, by way of example, and not limitation, implementations of the disclosure can comprise at least two distinctly different kinds of computer-readable media: computer storage media (devices) and transmission media.

Computer storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

An implementation of the devices, systems, and methods disclosed herein may communicate over a computer network. A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links, which can be used to carry desired program code means in the form of computer-executable instructions or data structures and which can be accessed by a general purpose or special purpose computer. Combinations of the above should also be included within the scope of computer-readable media.

Computer-executable instructions comprise, for example, instructions and data which, when executed at a processor, cause a general purpose computer, special purpose computer, or special purpose processing device to perform a certain function or group of functions. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure may be practiced in network computing environments with many types of computer system configurations, including, an in-dash vehicle computer, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, various storage devices, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Further, where appropriate, functions described herein can be performed in one or more of: hardware, software, firmware, digital components, or analog components. For example, one or more application specific integrated circuits (ASICs) can be programmed to carry out one or more of the systems and procedures described herein. Certain terms are used throughout the description and claims to refer to particular system components. As one skilled in the art will appreciate, components may be referred to by different names. This document does not intend to distinguish between components that differ in name, but not function.

It should be noted that the sensor embodiments discussed above may comprise computer hardware, software, firmware, or any combination thereof to perform at least a portion of their functions. For example, a sensor may include computer code configured to be executed in one or more processors, and may include hardware logic/electrical circuitry controlled by the computer code. These example devices are provided herein purposes of illustration, and are not intended to be limiting. Embodiments of the present disclosure may be implemented in further types of devices, as would be known to persons skilled in the relevant art(s).

At least some embodiments of the disclosure have been directed to computer program products comprising such logic (e.g., in the form of software) stored on any computer useable medium. Such software, when executed in one or more data processing devices, causes a device to operate as described herein.

While various embodiments of the present disclosure have been described above, it should be understood that they have been presented by way of example only, and not limitation. It will be apparent to persons skilled in the relevant art that various changes in form and detail can be made therein without departing from the spirit and scope of the disclosure. Thus, the breadth and scope of the present disclosure should not be limited by any of the above-described exemplary embodiments, but should be defined only in accordance with the following claims and their equivalents. The foregoing description has been presented for the purposes of illustration and description. It is not intended to be exhaustive or to limit the disclosure to the precise form disclosed. Many modifications and variations are possible in light of the above teaching. Further, it should be noted that any or all of the aforementioned alternate implementations may be used in any combination desired to form additional hybrid implementations of the disclosure.

1. An apparatus comprising:
a computing device including one or more processing devices and one or more memory devices operably coupled to the one or more processing devices, the one or more memory devices storing executable code that, when executed by the one or more processing devices, causes the one or more processing devices to:
transmit a first temporary license with an expiration date to a component executing on a host, the first temporary license authorizing the component to enable execution of managed software on the host; and
if a predefined time elapses without receiving a heartbeat message from the component, instruct the component to expire the first temporary license.

2. The apparatus of claim 1, wherein the executable code, when executed by the one or more processing devices, further causes the one or more processing devices to:
if the predefined time elapses without receiving the heartbeat message from the component, refuse a request from the component for a second temporary license for use upon expiration of the first temporary license.

3. The apparatus of claim 2, wherein the executable code, when executed by the one or more processing devices, further causes the one or more processing devices to:
if the predefined time does not elapse without receiving the heartbeat message from the component, transmit a second temporary license to the component for use upon expiration of the first temporary license.

4. The apparatus of claim 1, wherein the first temporary license specifies a number of nodes that may use the managed software.

5. The apparatus of claim 4, wherein the nodes are containers.

6. The apparatus of claim 1, wherein the host comprises a cluster.

7. The apparatus of claim 6, wherein the cluster is a KUBERNETES cluster.

8. The apparatus of claim 6, wherein the managed software comprises an orchestrator for deploying containers and application instances in the cluster.

9. The apparatus of claim 1, wherein the host is one or more servers.

10. The apparatus of claim 1, wherein the host is a cloud computing platform.

11. A method comprising:
transmitting, by a license server executing on a computing device, one or more temporary licenses to a component executing on a host, the one or more temporary licenses authorizing the component to enable execution of managed software on the host;
(a) determining, by the license server, that a predefined time has elapsed without receiving a heartbeat message from the component; and
in response to (a), refraining, by the license server, from transmitting an additional temporary license to the host.

12. The method of claim 11, further comprising:
in response to (a), refusing, by the license server, a request from the component for the additional temporary license.

13. The method of claim 12, wherein the one or more temporary licenses include a first temporary license and a second temporary license, the method further comprising:
(b) determining, by the license server, that the predefined time has not elapsed without receiving the heartbeat message prior to expiration of the first temporary license; and
in response to (b) transmitting, by the license server, the second temporary license to the host for use upon expiration of the first temporary license.

14. The method of claim 11, wherein the one or more temporary licenses specify a number of nodes that may use the managed software.

15. The method of claim 14, wherein the nodes are containers.

16. The method of claim 11, wherein the host comprises a cluster.

17. The method of claim 16, wherein the cluster is a KUBERNETES cluster.

18. The method of claim 16, wherein the managed software comprises an orchestrator for deploying containers and application instances in the cluster.

19. The method of claim 11, wherein the host is one or more servers.

20. The method of claim 11, wherein the host is a cloud computing platform.
